(19) United States
(12) Patent Application Publication
(10) Pub. No.: US 2003/0169182 A1
(43) Pub. Date: Sep. 11, 2003

(54) Position-based weather alert system

(76) Inventors: Andrew L. Wilhelm, Kokomo, IN (US); Bradley S. Coon, Kokomo, IN (US)

Correspondence Address: STEFAN V. CHMIELEWSKI, DELPHI TECHNOLOGIES, INC., Legal Staff Mail Code A-107, P. O. Box 9005, Kokomo, IN, 46904-9005, US

(21) Appl. No.: 10/090,605

(22) Filed: Mar. 5, 2002

(51) Int. Cl. G08G 1/09; G01W 1/00

(52) U.S. Cl. 340/905; 340/601

(57) ABSTRACT

An alert system 12 and a method for operating the same including a condition information receiver 28, which receives condition data 14 and generates a condition information signal 30, is provided. The condition alert system 12 also includes a positioning system receiver 27 receiving position data 17 and generating a position signal 29 in response to the position data 17. A system controller 31 is electrically coupled to the condition information receiver 28, the positioning system receiver 27, and an indicator 23. The system controller 31 indicates a condition alert signal via the indicator 23 in response to the condition information signal 30 and the position signal 29.

The present invention relates generally to a warning system for an automotive vehicle and more particularly, to an apparatus and method for providing condition alerts based on vehicle position.

### BACKGROUND OF THE INVENTION

For most vehicle operators traveling into undesirable or hazardous conditions is preferably avoided. Unless a vehicle operator has knowledge of approaching hazardous conditions the operator can not avoid operating a vehicle in or take proper precautions while operating a vehicle in the hazardous conditions.

Currently, emergency condition warnings are broadcast over FM/AM receivers or other audio devices based on location names. Location names, such as city or county names, have no relevance to an operator that is not familiar with his/her current surrounding area. Furthermore, an operator does not always receive condition warnings. For example, if the operator's FM/AM receiver is set to a channel that is not announcing the current hazardous conditions the operator is not aware of impending conditions. This is particularly true in satellite radio schemes in which the broadcasting station may be located across the country. Also when the operator is listening to some other audio entertainment device, such as a CD player, tape player, or other nonbroadcast device, condition warnings are not received by the operator. Therefore, many vehicle operators are not aware of potentially dangerous conditions in their immediate or upcoming area.

When a vehicle operator is aware of the surrounding hazardous conditions the operator has the opportunity to operate the vehicle with more knowledge of the conditions.

Therefore, it would be desirable to alert a vehicle operator of current hazardous conditions in the direction in which the vehicle is heading.

### SUMMARY OF THE INVENTION

The forgoing and other advantages are provided by an apparatus and method of operating an alert system for a hazardous condition. An alert system including a condition information receiver, which receives condition data and generates a condition information signal in response to the condition data is provided. The alert system also includes a positioning system receiver receiving position data and generating a position signal in response to said position data. A system controller is electrically coupled to the condition information receiver, the positioning system receiver, and an indicator. The system controller receives the condition information signal, the position signal, and couples a condition alert signal to the indicator in response to the condition information signal and the position signal.

A method of operating an alert system for a hazardous condition is also provided including receiving warning data and receiving position data. A current hazardous condition is indicated in response to said warning data and said position data.

The present invention has several advantages over existing hazardous condition broadcast methods. The present invention displays dynamically updated condition alert information based on the alert system position and heading direction.

Another advantage of the present invention is the ability to overlay the alert system position over a condition map and display this overlay as a visual image to the operator.

Yet another advantage of the present invention is provided by audible condition alerts, which override existing audio entertainment systems and audibly alert the operator of emergency conditions.

The present invention itself, together with further objects and attendant advantages, is best understood by reference to the following detailed description, with reference to the accompanying drawings.

### BRIEF DESCRIPTION OF THE DRAWING

For a more complete understanding of this invention reference should now be had to the embodiments illustrated in greater detail in the accompanying figures and described below by way of example.

In the figures:

FIG. 1 is a perspective view of an automotive vehicle within a communication network having an alert system according to the present invention.

FIG. 2 is a block diagram of an alert system according to the present invention.

FIG. 3 is a flow chart illustrating a method of alerting an operator of a current and upcoming hazardous condition based on a vehicle position in accordance with the present invention.

FIG. 4 is a perspective view of a vehicle relative to an alert area according to the present invention.

FIG. 5 is a flow chart illustrating an alert presentation algorithm in accordance with the present invention.

### DETAILED DESCRIPTION OF THE PREFERRED EMBODIMENT

The present invention may be applied in various applications such as in automotive vehicles, portable audio or video systems, residential or commercial audio or video systems, mobile computing platforms, handheld and laptop computers, or other various applications. The present invention alerts an operator of hazardous conditions and may be incorporated into existing vehicle communication systems. The present invention may be used to indicate to an operator hazardous conditions including: tornadoes, accidents, floods, chemical spills, or other various hazardous conditions.

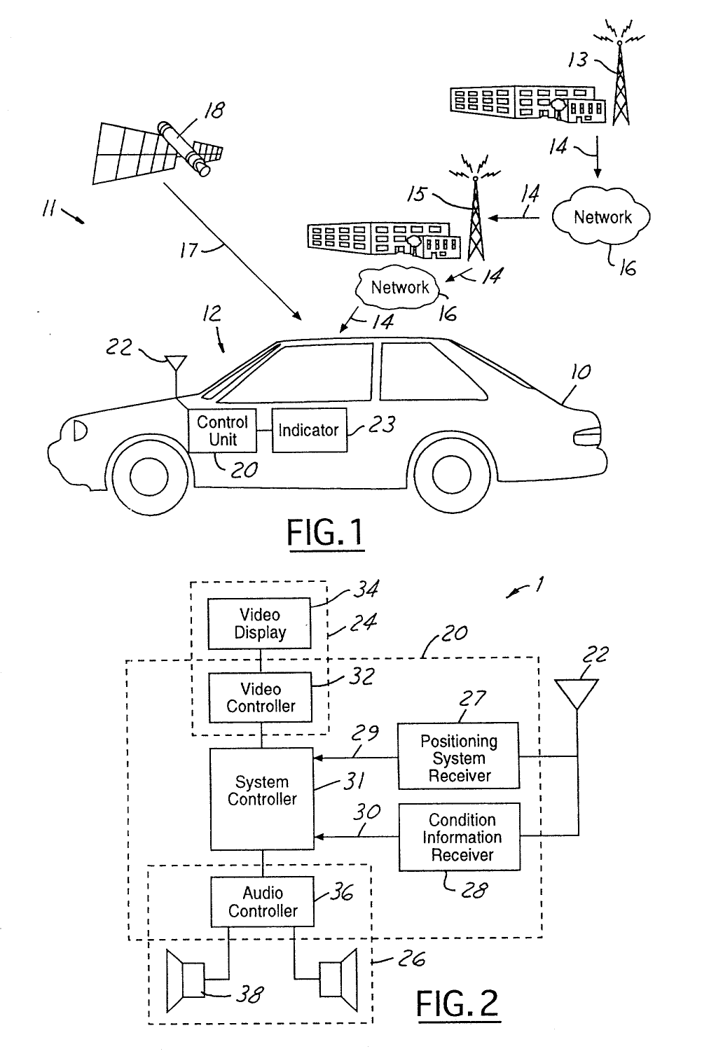

Referring now to FIG. 1, a perspective view of an automotive vehicle 10 within a communication network 11 having an alert system 12 according to the present invention is shown. The communication network 11 may include a broadcast station 13 for broadcasting hazardous conditions 14. The hazardous conditions 14 are transmitted to a data delivery center 15 via a wired or wireless network 16. The data delivery center 15 transmits condition data 14 to the alert system 12. The alert system 12 also receives position data 17 from satellites 18. The alert system 12 may be located within automotive vehicle 10.

The broadcast station 13 may broadcast local media data, weather data, and law enforcement data besides condition data.

Networks 16 may be wireless networks. Networks 16 may include subcarrier data systems, an analog cellular phone system, satellite systems, and digital wireless phone systems.

The data delivery center 15 may include radio stations, satellite media and data systems, television stations, cellular phone systems, and other systems.

The alert system 12 includes an alert system control unit 20, an antenna 22, and an indicator 23. Indicator 23 may be a portion of an audio system such as speakers, or navigation system, or may include an indicator light or status display in an indicator panel of the vehicle or a combination thereof. The control unit 20 may receive and transmit data via antenna 22 and convey a condition alert signal via indicator 23.

Referring now to FIG. 2, a block diagram of the alert system 12 according to the present invention is shown. In this example, indicator 23 is illustrated as part of both a video system 24 and an audio system 26. Alert system 12 includes an antenna 22 for receiving and transmitting data. The antenna 22 is connected to the control unit 20. The control unit 20 includes a positioning system receiver 27 for receiving vehicle position data 17 and a condition information receiver 28 for receiving condition data 14. The position data 17 and the condition data 14 are converted into a position signal 29 and a condition information signal 30 respectively and delivered to the system controller 31. The system controller 31 converts the position signal and the condition information signal 30 into a condition alert signal, which is conveyed to the operator via the video system 24 and the audio system 26.

The positioning system receiver 27 receives global positioning radio signals from satellites 18 and generates therefrom a vehicle position. The positioning system receiver 27 may be of any type known in the art and may be incorporated into the control unit 20 or may be a separate individual stand-alone device. Although the present invention uses a positioning system receiver 27, a Global Positioning System (GPS) receiver, an E911-compliant phone, or a data capable phone may be used as known in the art to determine alert system position.

The condition information receiver 28 receives condition data 14, which may be in the form of emergency or warning signals and generates therefrom a condition alert signal. The condition data 14 may be received from any of the following but is not limited to: a wireless data system, a personal communication service (PCS), a cellular data network, a short message service, a paging network, an FM subcarrier system, a satellite network, a broadband data service, a local area network, or other condition reporting system. The condition data 14 may have a header containing location or position information. The condition information receiver 28 may also be incorporated into the control unit 20 or may be a separate individual stand-alone device. The condition information receiver 28 may be any of the following: AM/FM receiver, wireless communication system, telematic system, GPS receiver, satellite receiver, or navigation system.

The system controller 31 after receiving the position signal 29 and the condition information signal 30 generates an overlay condition position signal 29 of the vehicle position on a generated condition map. The system controller 31 may use software or hardware in generating the overlay condition position signal. The system controller 31 may also combine the overlay condition position signal with a direction marker pointing in the direction the vehicle 10 is heading. The system controller 31, using the condition data 14, generates a condition alert signal to audibly signal a vehicle operator of current or upcoming hazardous conditions. The condition alert signal may be generated from a prerecorded voice, a live voice, or a text to speech (TTS) device. The system controller 31 may override the video system 24 and the audio system 26 in order to warn the operator of threatening hazardous conditions. The video and audio signals are dynamically updated relative to the position of vehicle 10. By knowing the position of vehicle 10, the heading of vehicle 10, and the location of prevailing hazardous conditions the system controller 31 may convey to an operator if vehicle 10 is moving closer to or farther away from the threatening hazardous conditions. The alert signal also includes the nature of the alert and the location of vehicle 10 relative to the hazardous condition. The alert system 12 may use icons to display a condition position.

The video system 24 includes a video controller 32 and a video display 34. The video controller 32 converts the overlay condition position signal to a generated video image seen by the operator via video display 34. The video image generated from the overlay condition position signal allows the operator to discern the position of vehicle 10 relative to the pending condition. Graphical symbols may be used to illustrate alert system 12 position relative to the condition position. The video system 24 may be one of various types of displays including a radar display, a navigation system, a telematic system, a data capable phone, a wireless-enabled personal digital assistant (PDA), a heads-up-display (HUD) system, or a video entertainment system. The video system 24 may convert specific area message encoding codes or use navigation link information to determine and indicate condition position. Although the present invention uses a video system 24 to visually alert an operator of current hazardous conditions an indicator of virtually any style may be used. Other indicators could be in form of a lighting system, which may be as simple as a “blinking” light emitting diode (LED).

The audio system 26 includes an audio controller 36 and audio speakers 38. The audio controller amplifies and conveys an audio portion of the condition alert signal to the operator via the audio speakers 38. The audio system 26 may be a vehicle stereo system, an entertainment system, a data capable phone, a wireless-enabled PDA, or any other sound-conveying device.

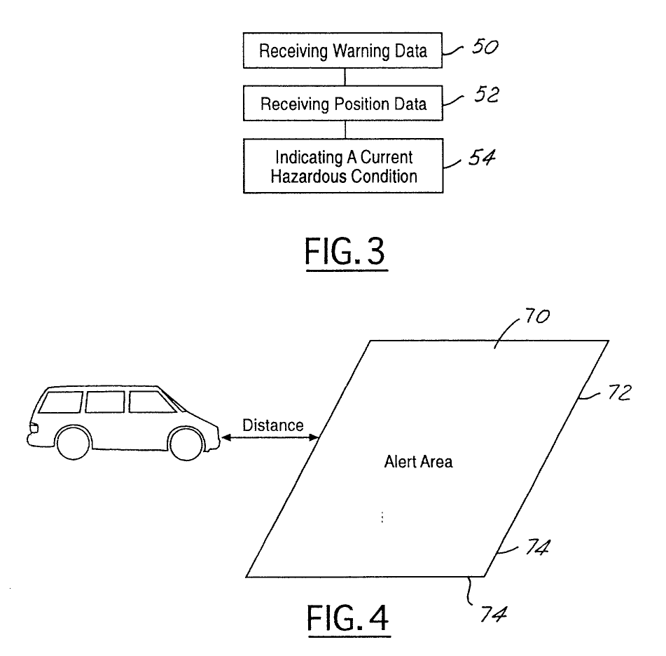

Referring now to FIG. 3, a flow chart illustrating a method of providing condition alerts based on a vehicle position in accordance with the present invention is shown.

In step 50, the control unit 20 receives warning data or condition data 14 and generates a condition alert signal 30 in response to the condition data 14. The condition alert signal 30 is generated using the condition information receiver 28.

In step 52, the control unit 20 receives position data 17 and generates a position signal 29 in response to said position data 17. The position signal 29 is generated using the positioning system receiver 27.

In step 54, the control unit 20 alerts or indicates to a vehicle operator of current hazardous or weather conditions. The control unit 20 generates a visual image, which includes a vehicle position overlaid on a condition map and displays the visual image on video display 34. The control unit 20 also displays the direction in which the vehicle 10 is heading. The control unit 20 may furthermore indicate audibly the current hazardous conditions via audio system 26.

Referring now to FIG. 4, a perspective view of vehicle 10 relative to an alert area 70 according to the present invention is shown. The alert area 70 is described as a set of positioning system coordinates defining a polygon 72. The borders 74 of the polygon 72 are determined by linear interpolation between the positioning system coordinates. The polygon 72 may be overlaid on a condition map, which may be displayed using video system 24. The vehicle position relative to the alert area 70 may also be indicated using the audio system 26 or video system 24. The distance between the vehicle 10 and the alert area 70 may also be calculated.

When the vehicle longitudinal and latitudinal positions are within the boundaries 74 of the polygon 72 then the vehicle 10 is in the alert area 70. When the vehicle position 10 is not within the alert area 70 the distance between the vehicle 10 and the alert area 70 may be calculated. The distance is indicated using the audio system 26 and the video system 24. The alert system 12 may indicate the longitudinal and latitudinal degrees, the distance in miles or kilometers, and the amount of time until the vehicle 10 is in the alert area 70 approximated according to vehicle 10 and condition speeds and heading directions.

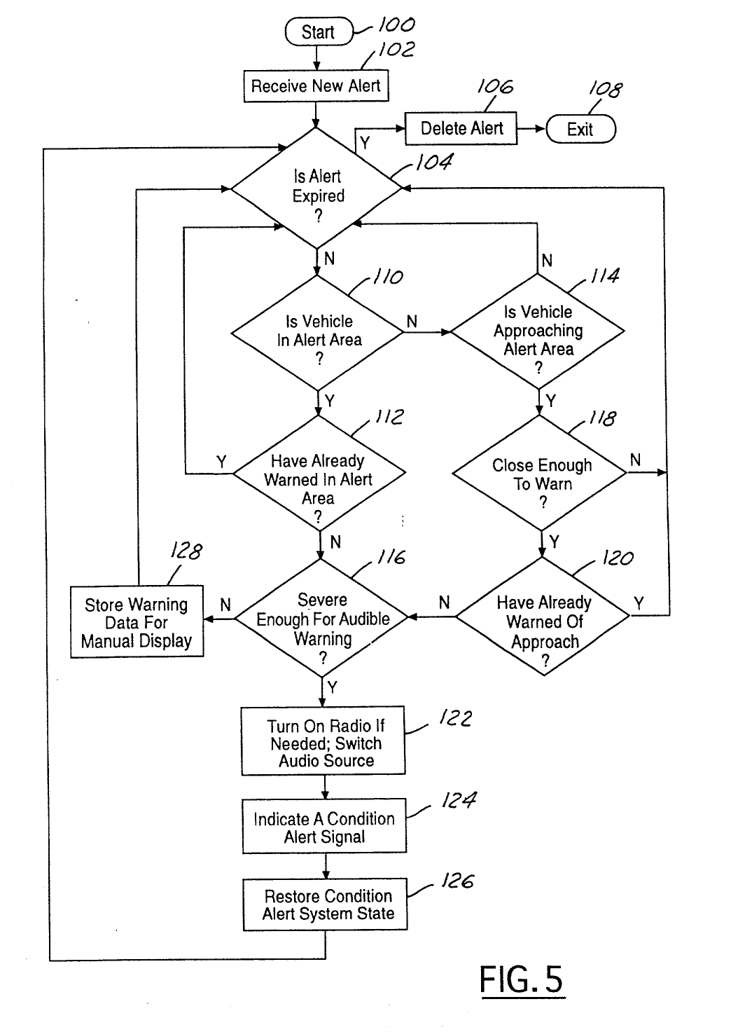

Referring now to FIG. 5, a flow chart illustrating an alert presentation algorithm in accordance with the present invention is shown.

In step 100, the alert system 12 is started. The alert system 12 is in “stand-by” until warning data is received.

In step 102, the alert system 12 receives a new alert signal. The new alert signal contains warning data 14.

In step 104, the alert system 12 determines whether a condition alert has expired. When the condition alert has expired step 106 is performed. When the condition alert is still in effect step 110 is performed.

In step 106, the alert system 12 removes the warning data 14 from system memory located within the system controller 30.

In step 108, the alert system 12 is exited and the vehicle returns to “normal” operation.

In step 110, the alert system 12 determines whether the vehicle 10 is in the alert area 70 based on the vehicle position data 17 and the warning data 14. When the vehicle 10 is positioned within the alert area 70 step 112 is performed otherwise step 114 is performed.

In step 112, the alert system 12 determines whether the alert system 12 has already indicated a condition alert signal or warning signal. When the alert system 12 has indicated the warning signal the system 12 return to step 104. When the alert system 12 has not indicated a warning signal step 116 is performed.

In step 114, the alert system 12 determines when the vehicle 10 is approaching the alert area 70. When the vehicle 10 is approaching the alert area 70, step 118 is performed otherwise the alert system 12 returns to step 104.

In step 118, the alert system 12 determines whether the distance between the system 12 and the alert area 70 is smaller than a predetermined value. When the distance is below the predetermined value the alert system 12 performs step 120 otherwise it returns to step 104.

In step 120, the alert system 12 determines whether the system 12 has already indicated a warning signal. When the system 12 has indicated a warning signal the system 12 returns to step 104 otherwise step 116 is performed.

In step 116, the alert system 12 determines whether the hazard level of the warning data 14 is above a predetermined value as to indicate a warning signal. When the level of the warning data 14 is above a predetermined value, step 122 is performed otherwise system 12 performs step 128.

In step 122, the alert system 12 “overrides” the audio system 26 and video system 24 to indicate a warning signal. The alert system 12 powers “on” the audio system 26 and video system 24 when they are not receiving power.

In step 124, the alert system 12 indicates the condition alert signal or the warning signal. The condition alert signal may be an audio signal or video signal or a combination thereof.

In step 126, the alert system 12 restores the system 12 to its initial state when powered “on”, as in step 100.

In step 128, the alert system 12 stores the warning data 14 for manual display.

The constructed embodiment in combination with the above described method of the present invention provides an alert system that alerts a vehicle operator of emergency conditions within a close proximity of the operator's vehicle. Even if the operator is familiar with the surrounding area, with the alert system, the operator is aware of the current hazardous conditions and may choose to take any necessary precautions. The increased awareness of the operator increases the degree of safety for the operator and others.

The above-described apparatus and method, to one skilled in the art, is capable of being adapted for various purposes and is not limited to the following applications: automotive vehicles, portable audio or video systems, residential or commercial audio or video systems, or other various applications. The above-described invention can also be varied without deviating from the true scope of the invention.

While particular embodiments of the invention have been shown and described, numerous variations and alternate embodiments will occur to those skilled in the art. Accordingly, it is intended that the invention be limited only in terms of the appended claims.

What is claimed is:

1. A alert system comprising:
a condition information receiver receiving condition data and generating a condition information signal in response to said condition data;
a positioning system receiver receiving position data and generating a position signal in response to said position data;
an indicator; and
a system controller electrically coupled to said condition information receiver, said positioning system receiver, and said indicator, said system controller receiving said condition information signal, said position signal, and coupling a condition alert signal to said indicator in response to said condition information signal and said position signal.

2. A system as in claim 1 wherein said indicator is selected from the following group comprising: a video system, an audio system, a lighting system, and a heads-up display system.

3. A system as in claim 1 further comprising:
a video system electrically coupled to said system controller; and
an audio system electrically coupled to said system controller;
wherein said system controller indicates said condition alert signal on said video system and said audio system.

4. A system as in claim 1 wherein said condition is the weather.

5. A system as in claim 3 wherein said video display system is selected from the following group: a radar display, a data capable phone, a personal digital assistant, a navigation system, a telematic system, and a video entertainment system.

6. A system as in claim 3 wherein said audio system receives data selected from the following group: recorded voice, warning tones, and text-to-speech.

7. A system as in claim 3 wherein said system controller receives said position signal and signals said video display system.

8. A system as in claim 7 wherein said system controller combines said condition information signal with said position signal to form an overlay condition position signal.

9. A system as in claim 7 wherein said system controller also indicates a heading direction of the condition information receiver.

10. A system as in claim 1 wherein said condition information receiver is selected from the following group: AM/FM receiver, wireless communication system, telematic system, satellite receiver, and navigation system.

11. A system as in claim 1 wherein said audio system is selected from the following group: a vehicle stereo system, an entertainment system, and a sound-conveying device.

12. A system as in claim 1 wherein said condition information receiver receives condition data from one selected from the following group: radar system, wireless data system, personal communication service, cellular data network, short message services, paging network, FM subcarrier system, satellite network, broadband data services, and local area networks.

13. A method of operating an alert system for a hazardous condition comprising:
receiving warning data corresponding to the hazardous condition;
receiving position data; and
indicating the current hazardous condition in response to said warning data and said position data.

14. A method as in claim 13 wherein warning data comprises receiving data containing information on the hazardous condition selected from the following group: weather data, tornado data, hazardous chemical spill data, and accident data.

15. A method as in claim 13 wherein said indicating a current hazardous condition further comprises:
displaying a condition map on a video display;
overlaying a condition alert system position on said video display; and
indicating a condition alert system heading.

16. A method as in claim 13 wherein indicating a hazardous condition further comprises:
overriding vehicle audio entertainment systems; and
generating an audio signal on a vehicle audio entertainment system.

17. A method as in claim 16 wherein said generating an audio signal comprises audibly transmitting a signal formed from one selected from the following group: a prerecorded voice, a live voice, and a text to speech device.

18. A method as in claim 13 further comprising dynamically updating condition data based on a condition alert system position.

19. A method as in claim 13 wherein indicating a current hazardous condition further comprises calculating a condition alert system position relative to an alert area.

20. A method as in claim 13 further comprising displaying an overlay of a condition alert system position on a generated condition map on a video display.

21. A method as in claim 13 further comprising displaying a heading direction of a condition alert system.

22. A vehicle alert system comprising:
a condition information receiver receiving condition data and generating a condition information alert signal;
a positioning system receiver receiving position data and generating a position signal;
a video system;
an audio system;
a system controller electrically coupled to said condition information receiver, said positioning system receiver, said video system, and said audio system, said system controller in response to said condition information alert signal and said position signal forming an overlay condition position signal;
said system controller indicating said overlay condition position signal on said video system and said audio system.
